(19) United States
(12) Patent Application Publication
(10) Pub. No.: US 2005/0160194 A1
(43) Pub. Date: Jul. 21, 2005

(54) Method of limiting amount of waste paper generated from printed documents

(76) Inventors: Joseph J. Bango, New Haven, CT (US); Michael E. Dziekan, Naugatuck, CT (US)

Correspondence Address: CONNECTICUT ANALYTICAL CORPORATION;JOSEPH J. BANGO, 696 AMITY ROAD, BETHANY, CT, 06524, US

(21) Appl. No.: 11/035,542

(22) Filed: Jan. 14, 2005

Related U.S. Application Data
(60) Provisional application No. 60/537,084, filed on Jan. 16, 2004.

(51) Int. Cl. G06F 3/00

(52) U.S. Cl. 710/8

(57) ABSTRACT

This invention details a method of providing a method of limiting the amount of waste paper created when printing documents. One of the main problems encountered by today's business environments is the generation of tons of waste paper. With the current trend in maintaining a “recycle minded” mentality, it would seem obvious that in preference to recycling used paper, what is needed is a process that limits a amount a waste paper in the first place.

### CROSS REFERENCE TO RELATED APPLICATIONS:

Provisional Application No. 60/537084 was filed on 16 Jan. 2004

### BACKGROUND

1. Field of Invention

This invention details a method of providing a method of limiting the amount of waste paper created when printing documents. One of the main problems encountered by today's business environments is the generation of tons of waste paper. With the current trend in maintaining a “recycle minded” mentality, it would seem obvious that in preference to recycling used paper, what is needed is a process that limits a amount a waste paper in the first place.

2. Background Description of Prior Art

In order to understand why this invention would be beneficial for today's business world, we need to investigate as to why so much paper is wasted in the first place. One of the most common “wasters” of paper is when pages are printed from a website. What usually happens is that an individual will be using a web browser such as Microsoft's Internet Explorer, or Netscape's Navigator, and want to print out the information from the current web page. What most people will do is simply click the print button on the toolbar. What will usually happen next is that a small window will appear displaying information as to how many pages are to be printed out of a total number of pages. For example it might indicate that it is printing page 2 of a total of 2 pages. Ultimately, what transpires next is that the last page contains a line or two of useless information, sometimes it will only be a single line of text indicating “Page 2 of 2”. What this means is that the computer cannot distinguish between relevant and non-relevant information. The user relegates the undesired page(s) to the recycle bin and proceeds to deposit the nearly blank wasted page into the recycle bin. If a way of determining how much text is on the last page can be realized, then a significant amount of “waste paper” can be eliminated from a business. This will be seen as a cost saving to companies, individuals, and a resource savings to the environment.

### BRIEF DESCRIPTION OF THE DRAWINGS

FIG. 1:

Detail of a typical 8.5″×11″ sheet of paper from a printer.

FIG. 2:

Screen shot of a menu detailing the printer functions.

FIG. 3:

Detail of two sheets of 8.5″×11″ sheets of paper from a printer.

FIG. 4:

Detail of a single sheet of 8.5″×11″ paper from a printer that has been converted from grayscale to a monochrome (Black & White) image.

FIG. 5:

Detail of a single sheet of 8.5″×11″ paper from a printer that has been converted from grayscale to a monochrome (Black & White) image detailing the rows of segmentation to be filled in where text is present.

FIG. 6:

Detail of a single sheet of 8.5″×11″ paper from a printer that has been converted from grayscale to a monochrome (Black & White) image detailing the rows of segmentation filled in where text is present.

FIG. 7:

Detail of a single sheet of 8.5″×11″ paper from a printer that has been converted from grayscale to a monochrome (Black & White) image detailing the rows and columns of segmentation to be filled in where text is present.

FIG. 8:

Detail of a single sheet of 8.5″×11″ paper from a printer that has been converted from grayscale to a monochrome (Black & White) image detailing the rows and columns of segmentation filled in where text is present.

FIG. 9:

Close up detail of a small portion of the single sheet of 8.5″×11″ paper from a printer that has been converted from grayscale to a monochrome (Black & White) image detailing the increased resolution of the rows and columns contained in a single segmentation area that will be filled in where text is present.

FIG. 10:

Close up detail of a small portion of the single sheet of 8.5″×11″ paper from a printer that has been converted from grayscale to a monochrome (Black & White) image detailing the increased resolution of the rows and columns contained in a single segmentation area filled in where text is present.

FIG. 11:

Exploded view of a single segmented area from the single sheet of 8.5″×11″ paper from a printer that has been converted from grayscale to a monochrome (Black & White) image detailing the increased resolution of the rows and columns contained in a single segmentation area filled in where text is present.

FIG. 12:

Detail of two letters, one straight, and one slightly rotated.

FIG. 13:

Detail of several common font sizes showing the size relationship to each other.

### DETAILED DESCRIPTION OF INVENTION

In order to print out documents from a typical personal computer (PC), one needs a printer attached directly to the PC or indirectly through some network connection that contains a networked printer. What is also required are the appropriate printer drivers required for that particular printer, and for the appropriate operating system that is installed on the PC. For discussion purposes, PC will refer to a general computer of a non-specific make, OS (Operating System) and model. The PC could be an IBM type personal computer, an Apple type personal computer, or a Unix type personal computer. The term of personal computer equally applies to small, lightweight laptop computers, to large main frame computers with a plurality of terminals. As a simple example, one might have a Tektronix Phasor 740 printer connected to a PC running Microsoft Windows XP. The type of printer used, and the type of operating system used is not critical, but are only meant to serve as an example. As stated previously, one could just as easily use a Macintosh computer running Operating System 9.1 with an attached Hewlett Packard printer. What does matter is that all the appropriate printer drivers are installed onto the correct operating system for the PC that is connected to the printer. Some programs that are typically used on PC's have a selection on the file menu of the toolbar that lets one perform a “Print preview”. The print preview allows the user to look at how the page or pages are formatted for the installed printer. It will give one an indication as to how the text will be arranged on the page or pages when they are printed out. Sometimes a single letter or word will be forced onto a new page, which will end up wasting an entire sheet of paper. The user then has the option of rewording a sentence to cause all of the words to fit on the main page, and will alleviate the wasted page, or they can simply resize the text, or change the print margins to do the same thing. This is a common feature on almost all word processing programs, such as Microsoft Word. This is easy to do if one is the author of the document, but once it is created, it might have to be printed out by another individual with most likely another type of printer. This can result in reformatting problems, what was originally three pages, could now be four pages, with the extra page containing a single character or word. This wastes paper. It is much worse if someone is trying to print out information from a web page on the World Wide Web (www). What usually happens is that there is an extra page containing information about the company that is not really of interest, or has redundant information, or some elaborate graphics that the user does not require.

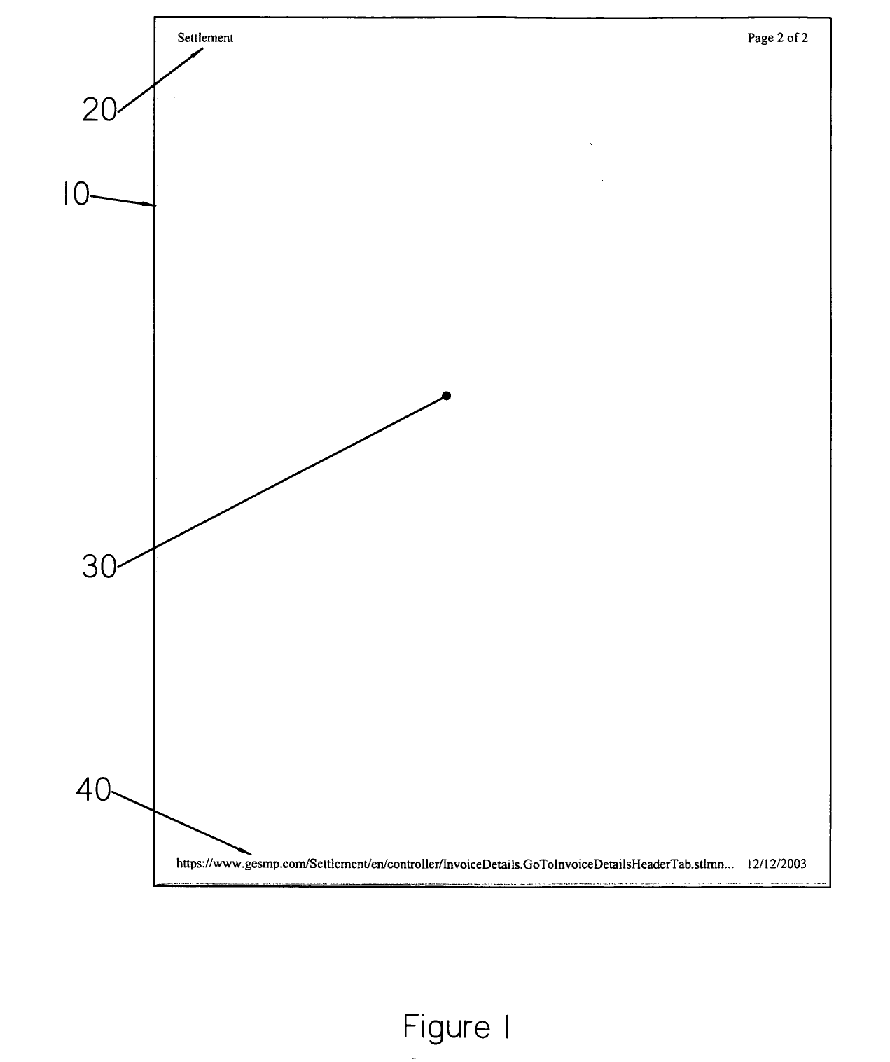

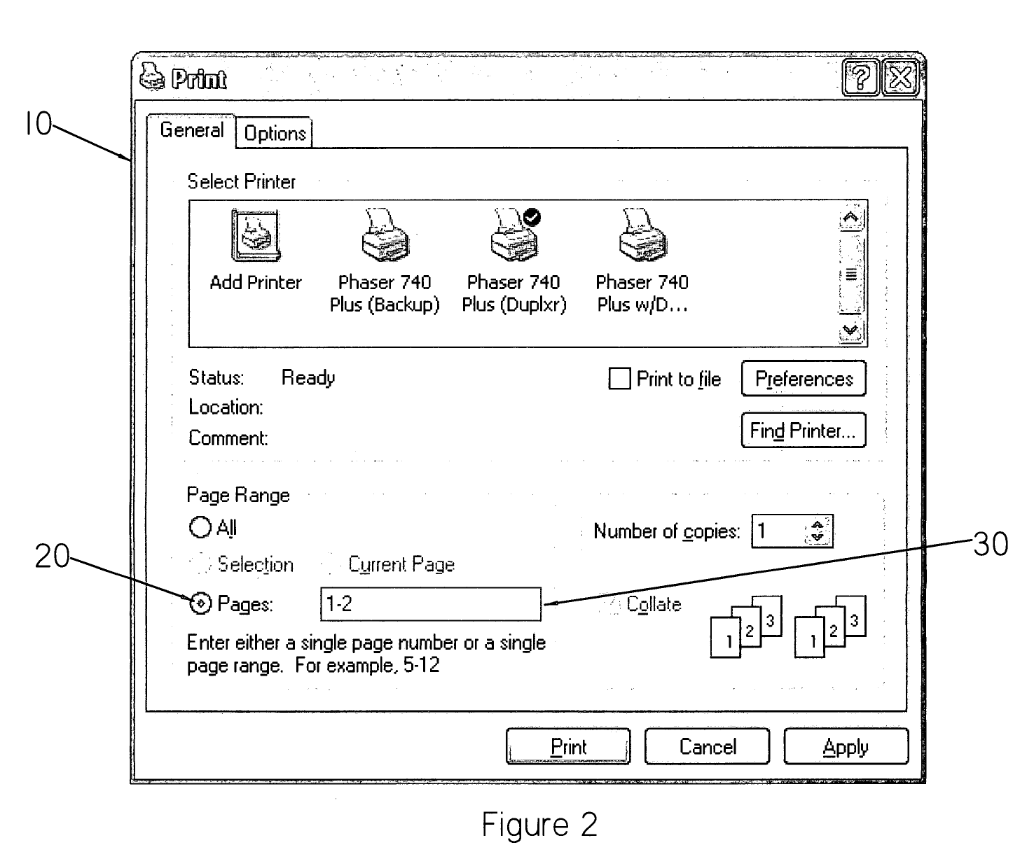

FIG. 1 shows a sheet of paper 10 that was printed out on a laser printer. The paper 10 was originally two pages of information, the first page was completely filled with text and graphics, while the remaining page contained no text or graphics related to the original website. As can be easily seen, the page 10 is nearly completely blank 30, and only contains a single line of text 20 at the top of the page, and a single line of text 40 at the bottom of the page. This page 10 would be discarded into either the trash or an appropriate recycle bin. There are several means to alleviate this kind of waste, one method that can be used is to manually view a print preview from a suitable web browser, such as Microsoft's Internet Explorer, or Netscape's Navigator. When using Microsoft's Internet Explorer, a print preview menu option could be used to see how the page or pages would be printed. If one has determined that there are three pages of information from a particular website, and that the third page contains only a single line of data, the user has the option of only printing out the first two pages. FIG. 2 shows a printer menu that would be commonly seen when using a Windows XP Home Version operating system running on an IBM compatible PC, while using Microsoft's Internet Explorer. The print menu 10 has a page range selection that could be used to print out a specific range of pages. If only the first two pages are wanted, then the page range “Pages” 20 option is clicked with the mouse, and the page range is typed into the page range text box 30. In this case, since only the first two pages are wanted, the page range text box 30 would contain the text “1-2”. This tells the operating system to send only page one and page two to the printer. The result is that the third page is not printed out, and paper is saved. The drawback is that this can become very time consuming, and if there were some additional relevant information on the third page, it would not be printed out. What is needed is a method to determine how much text and graphics are included on the last page, and scale the page to maximize the amount of text on each page.

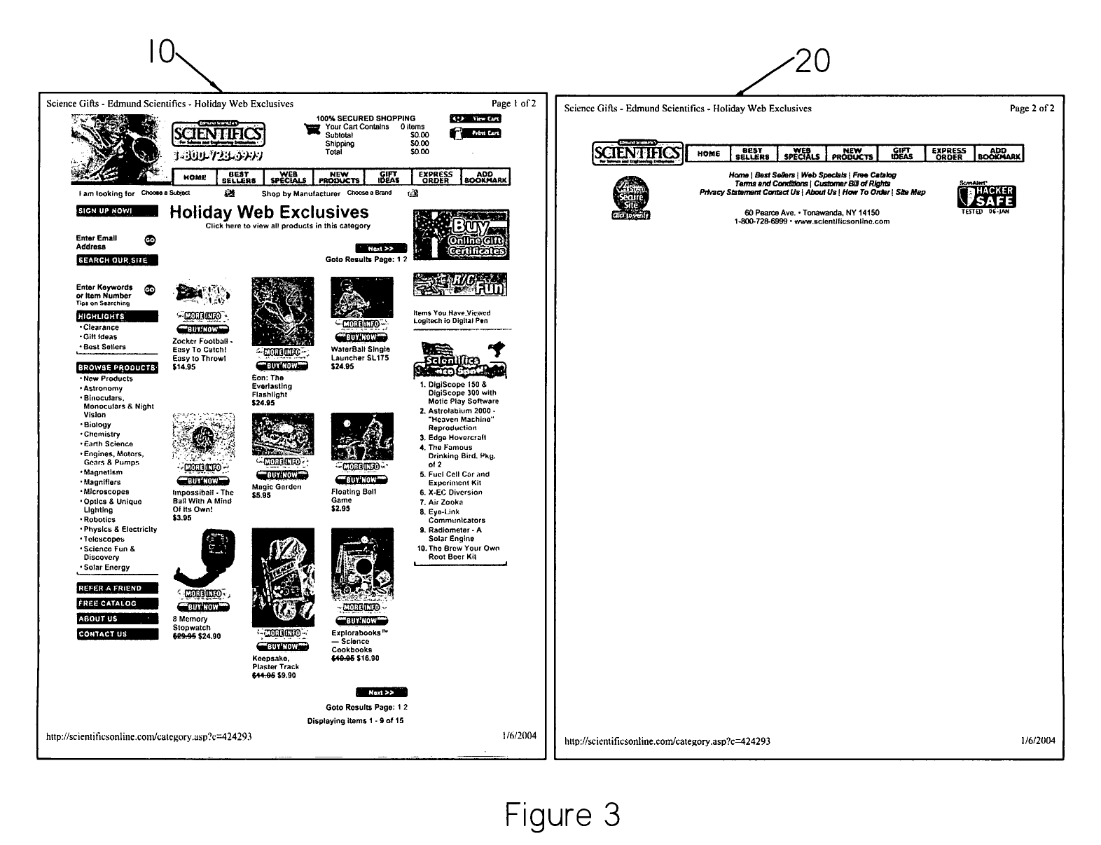

FIG. 3 shows a printout from the “Edmund Scientifics” website. There are two pages, page one 10 and page two 20. It can easily be seen that page one 10 contains all the information that a person would need to order or reference any of the items for purchase, while page two 20 contains only minor additional information. The phone number to “Edmund Scientific” is contained on the first page 10, along with most of the graphics. The only additional piece of information is the address of the company. The second page 20 will end up being discarded or recycled. If the operating system software running on the PC were able to include a “Paper Saver” option in the print menu, then thousands of innocent trees would be spared! Blank pages could be set to be automatically deleted or more accurately, not printed. This would prevent any blank section from being printed, and thus wasting a sheet of paper.

In the situation as in FIG. 1 where there is only a single line of text at the top of the page 20, and at the bottom of the page 40, this would be quite easy to implement. When the user issues a print command, the operating system software would then check to see if the “Paper Saver” option has been checked. If the “Paper Saver” option has been checked, then the operating systems printer handler software would determine how much space is occupied by text on the last page. If only a few lines of text are on the last page, the disclosed invention will either delete the last page automatically before sending the data to the printer, or an optional window is configured to “pop-up” on the viewers monitor screen showing the last page, prompting the user if they want this page printed out. While it would be extremely complex to add code that would try to infer content from each page and try to determine if the information already exists on any of the previous pages, such action would represent another possible embodiment of the disclosed invention. It is far easier and quicker to pop-up the image of the last page on the computer's monitor and let the user decide if they should print out the last page or not. Another optional function would allow a user to always neglect to print out the last page when a hard copy from various websites is being sought, where the user may so tag such sites as they are visited or where such list is entered either manually or via a download list. In most cases, the last page from a website contains only superfluous information and some unnecessary graphics. The process of “reading” how much text would be contained on a sheet of printed paper is a trivial matter of looking at the coding information detailing how the page will print out. While several means exist to determine this information, in the preferred embodiment, counting how many spaces and tabs are contained on the page compared to how many characters (letters and numbers) allow a limit or threshold to be set where printed data is omitted. It is obvious to those skilled in the art that other information could be used to determine how much of a page is used, such as page breaks, returns, and line feeds. When viewing pages in a “Print Preview” menu, the text and graphical information is viewed through a graphical picture box or image box. It is essentially a picture of the document, such as a common bitmapped (BMP) image. A simple method of determining how much text and graphics is contained on a page is to first convert the image to a strictly monochrome image or black & white image.

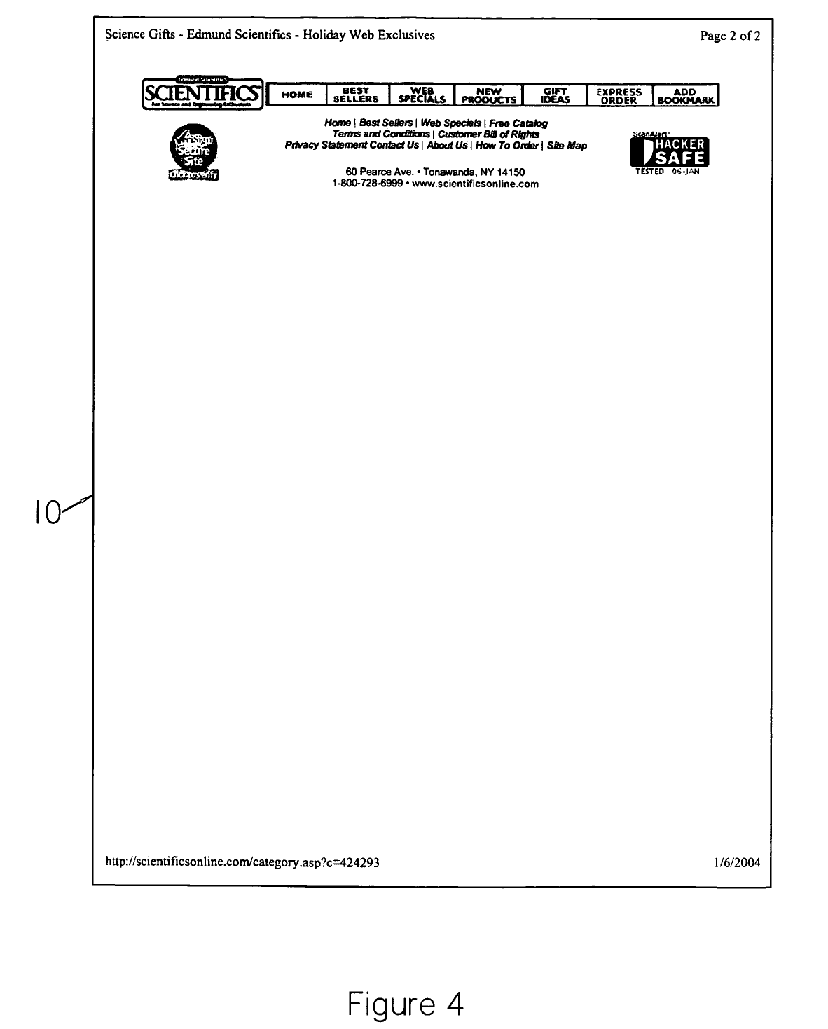

FIG. 4 shows the second page 10 of the printout from the “Edmund Scientifics” webpage. There was originally color information contained in this image, but for the purposes of trying to determine how much text and graphics are contained on the entire page, every pixel is simply converted to black after being processed with a suitable thresholding algorithm to remove any colored background that may be contained in the document. By examining the page contents in this mannor, one does not have to utilize processor resources to determine if a section of the image contains text or a part of an image. Only the user would know exactly what they would require, and it would be impossible for the software to determine if a graphic should be printed or not. The context of the message would have to be determined, and this would require an expensive software package with character recognition and artificial intelligance. A simpler method is to just look at the quantity of information on a page.

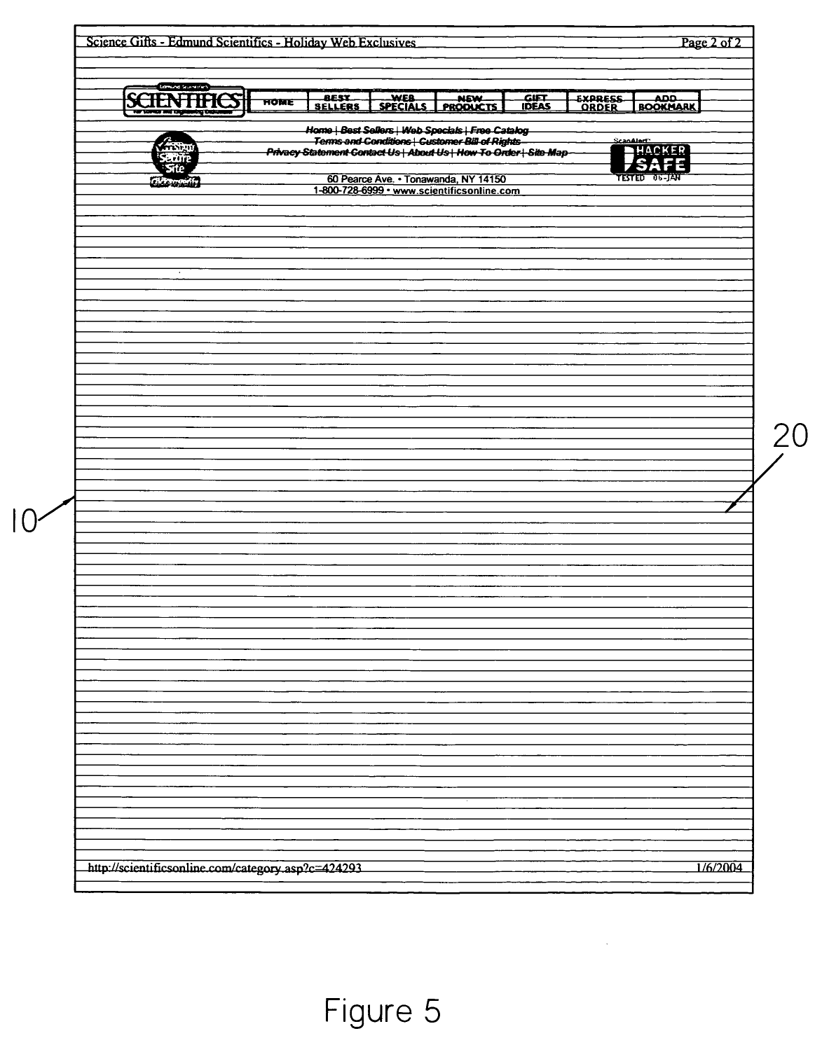

FIG. 5 outlines step two of the described process in which the image of the page 10 from the “Edmund Scientifics” website be artificially divided into rows 20. The number of rows is not nessacarily fixed. The software could divide the image of the page into one hundred equal rows, as easily as fifty equal rows; however, the more rows, the more accurate the results. In this example, the number of rows is set at eighty-two rows. Each row 20 will be scanned by software and the presence of any black pixels contained in that row will cause the row to be considered filled.

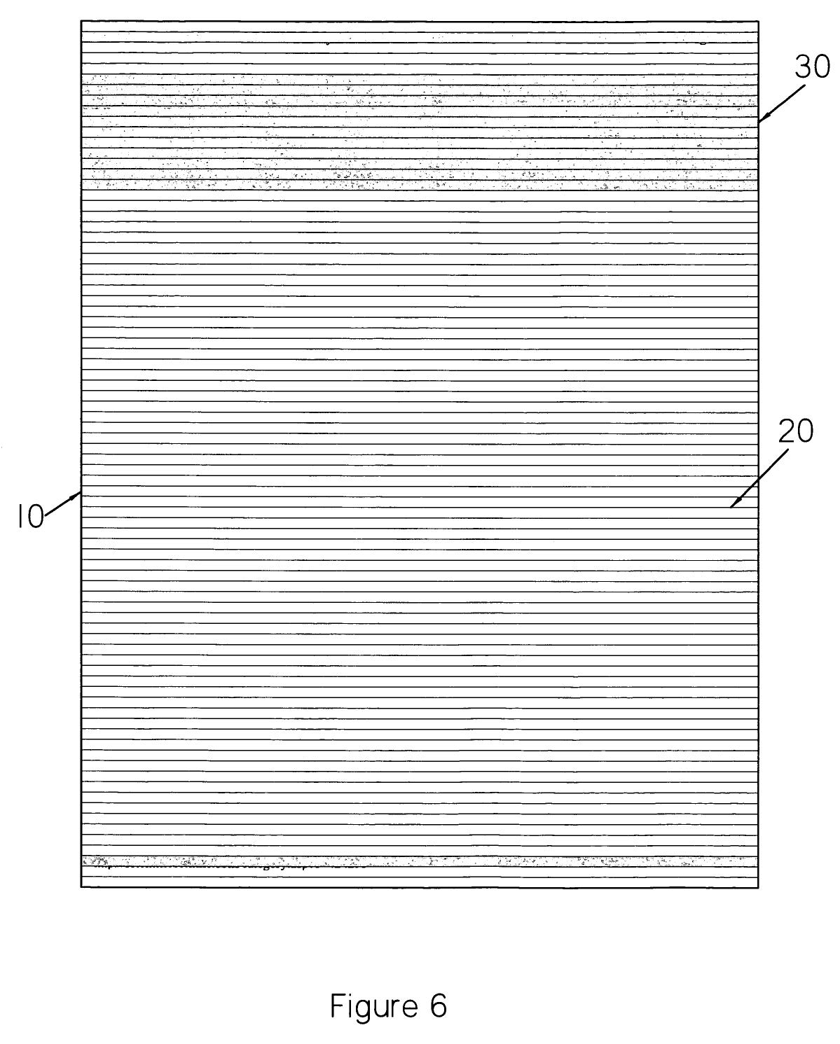

FIG. 6 details how the software would indicate that there is text or graphics located in the specific rows 20. The image of the page 10 is divided into equal artificial rows 20, and wherever there are pixels that are connected to each other that are more than half way from top to bottom, or from bottom to top, of the individual rows 20, that row is marked or designated as having text or graphics. In our example, the row 20 is shown as being shaded 30 to indicate that it is marked as containing text or graphics. A percentage can then be calculated as to what percent of the page contains text or graphics. The number of rows that are indicated as shaded 30, that is, containing text and graphics is compared to the number of rows 20 that are indicated as empty. The ratio of these two values will indicate a percentage. This percentage would be used to determine if the software would print out the page or not. In this example, there are eighty-two rows 20 on the entire page (it could just as easily be one hundred, two hundred and three, or five hundred rows), with thirteen rows indicated as having text or graphics 30. The percentage would then be the number of rows marked as having text or graphics 30 divided by the total number of rows on the page 20, this result is then multiplied by one-hundred to get a percentage. In our example the percentage would be:
(Number of rows containing text or graphics/Total number of rows)×100=Percent
(13/82)×100=15.85%

Our example indicates that only 15.85% of the entire page contains text or graphics. The exact percentage that would indicate whether a page is printed out or not would have to be determined or optionally, a value could be set by the user. If the user set the threshold to 16%, then anything less than 16% would not be printed out, or more precisely, the last page would not be printed out. Our example shows that in this case, the last page would not be printed out. The percentage value would change based upon how many equal rows the page is divided into. If the page were only divided into fifty equal rows, then a higher percentage would be necessitated, while if the page is divided into one hundred equal rows, then a lower percentage could be used to give the same results. The preferred embodiment of this invention would set the number of rows to one hundred. In this case, the number of rows that are marked or designated as containing text or graphics, would be the percentage. If three rows are indicated as containing text or graphics, then the result will be three percent. If twenty-one rows are indicated as containing text or graphics, then the result will be twenty-one percent. No further calculations are involved. For more precise detail as to the percentage of text and graphics contained on a page image, the image could be divided up into equal numbers of columns in addition to rows.

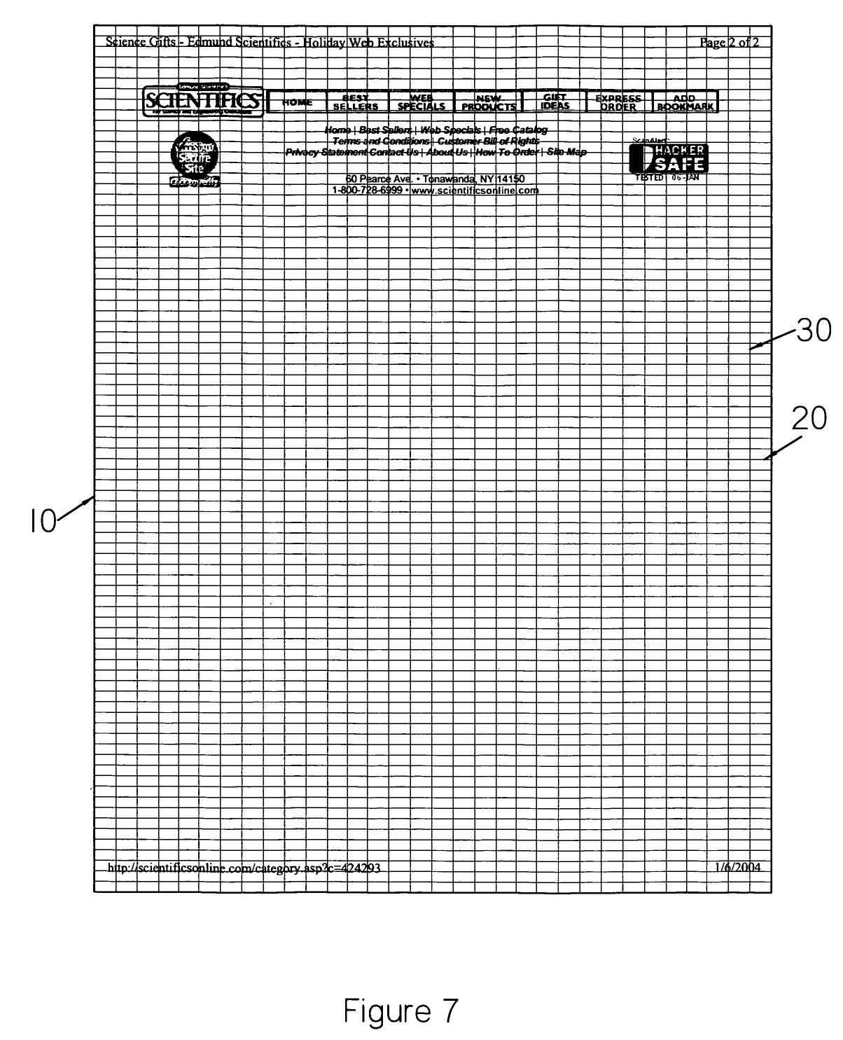

FIG. 7 indicates the same page image 10 divided up into the same number of eighty-two equal rows 20, with the addition of equally spaced columns 30. In this example, the number of equally spaced columns is thirty-two. This number could also be set to a higher amount, such as one hundred. The individual grids will now be checked for text and graphics information in a similar manner.

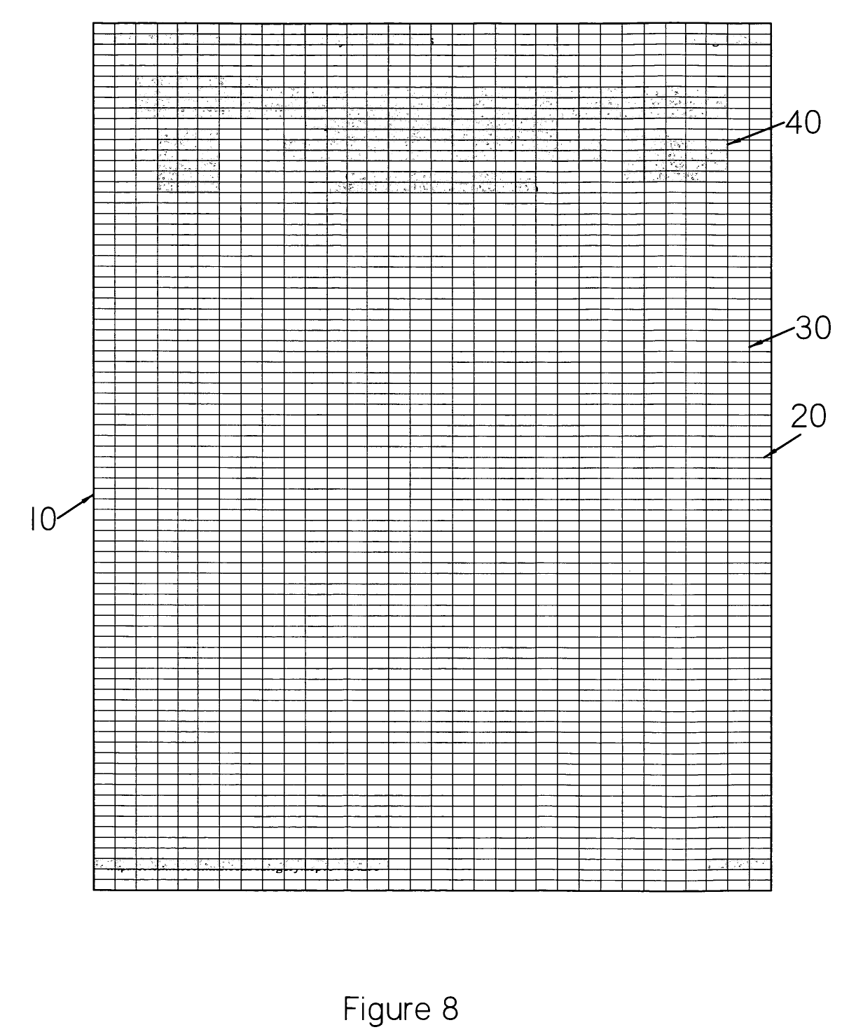

FIG. 8 details how each grid 40 will be marked as having text or graphic information. The page image 10 is divided up artificially into rows 20 and columns 30. Each grid, or box between rows and columns will be checked for the black pixels, if any pixels are contained that travel more than half way from the top of the grid to the bottom of the grid (or vice-versa), then that grid will be marked as having text or graphics 40. In this example, there are eighty-two rows 20, and thirty-two columns 30. This means that there are a total of two thousand, six hundred and twenty-four grids contained on the page image. If we use our previous formula to determine percentage, we then obtain:
(Number of grids containing text or graphics/Total number of grids)×100=Percent
(238/2624)×100=9.07%

This is a much more refined method of determining percentage of the page that is covered with text or graphics. Again, the user can input a number into the software that will be used as a cutoff point or threshold for printing out a page. If the cutoff point is ten percent, then this last page 10 will not be printed out.

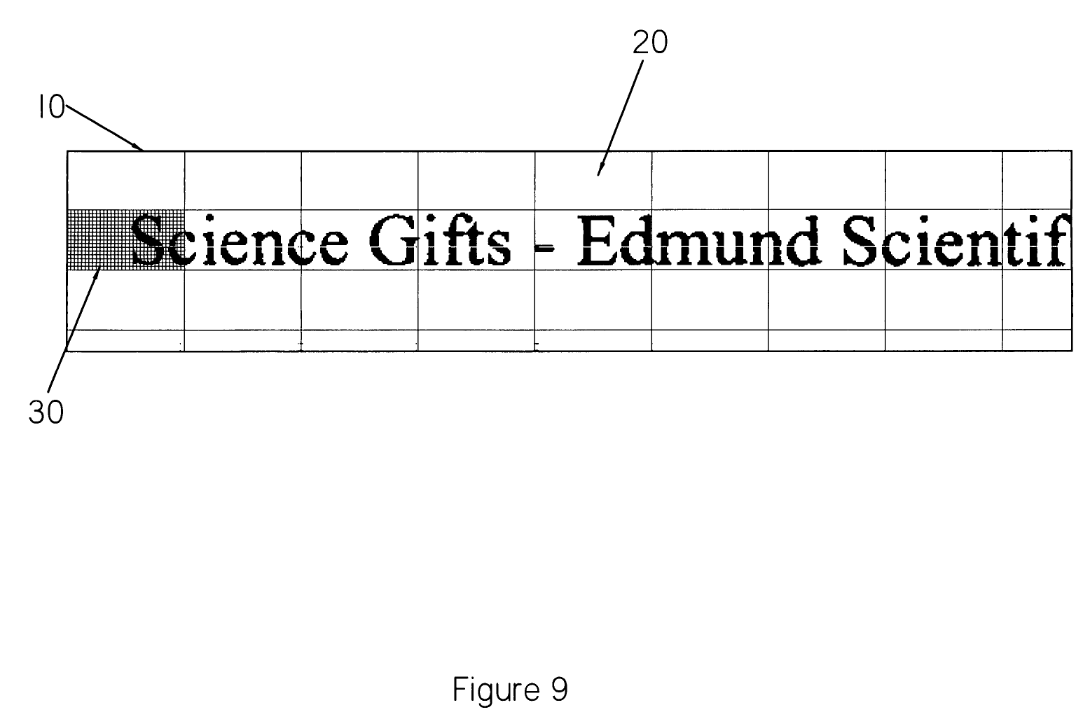

FIG. 9 details how the software would make the determination as to which grids get marked as having text or graphics in them. The page image is expanded for easy viewing 10. Each grid 20 would be further subdivided into smaller grids 30, in this example there are sixteen rows and thirty-two columns contained in each grid. The number of small grids 30 contained in each large grid 20 is five hundred and twelve.

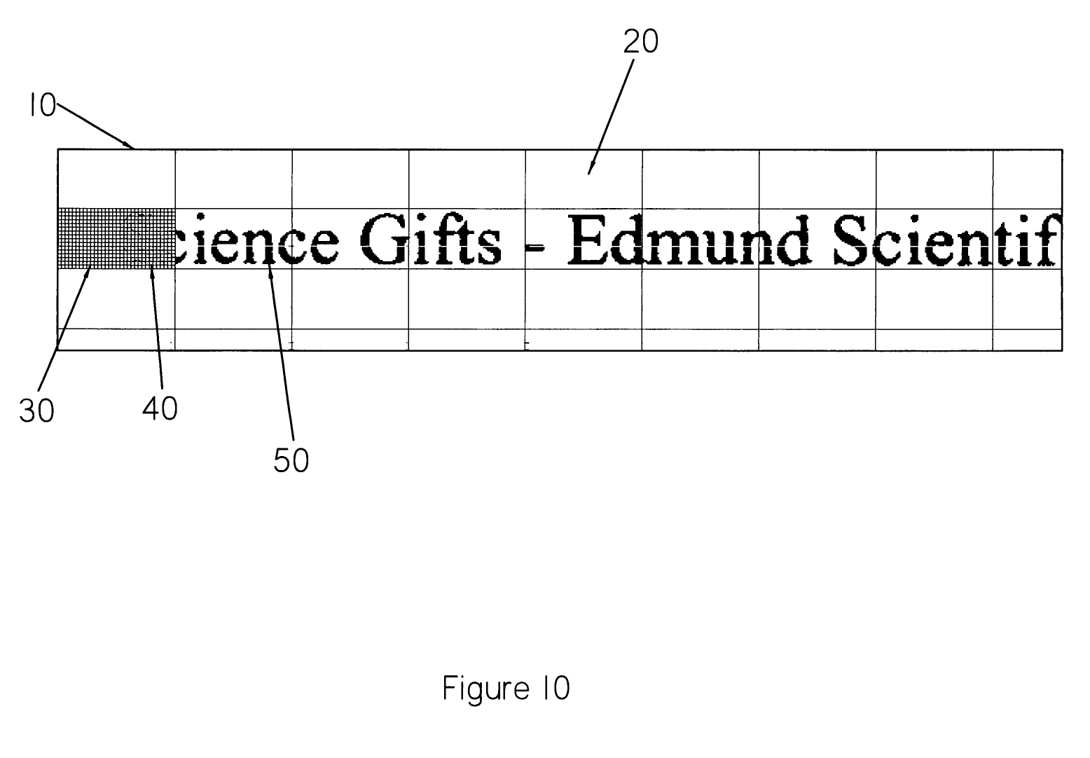

FIG. 10 shows the same expanded page image section 10 as before, and the small grids 30 and large grids 20. The small grids 30 that contain text or graphics (black pixels) will be marked as containing text or graphics 40. In our example, the text 50 contained inside each small grid 30 is marked as a grayed out grid box 40.

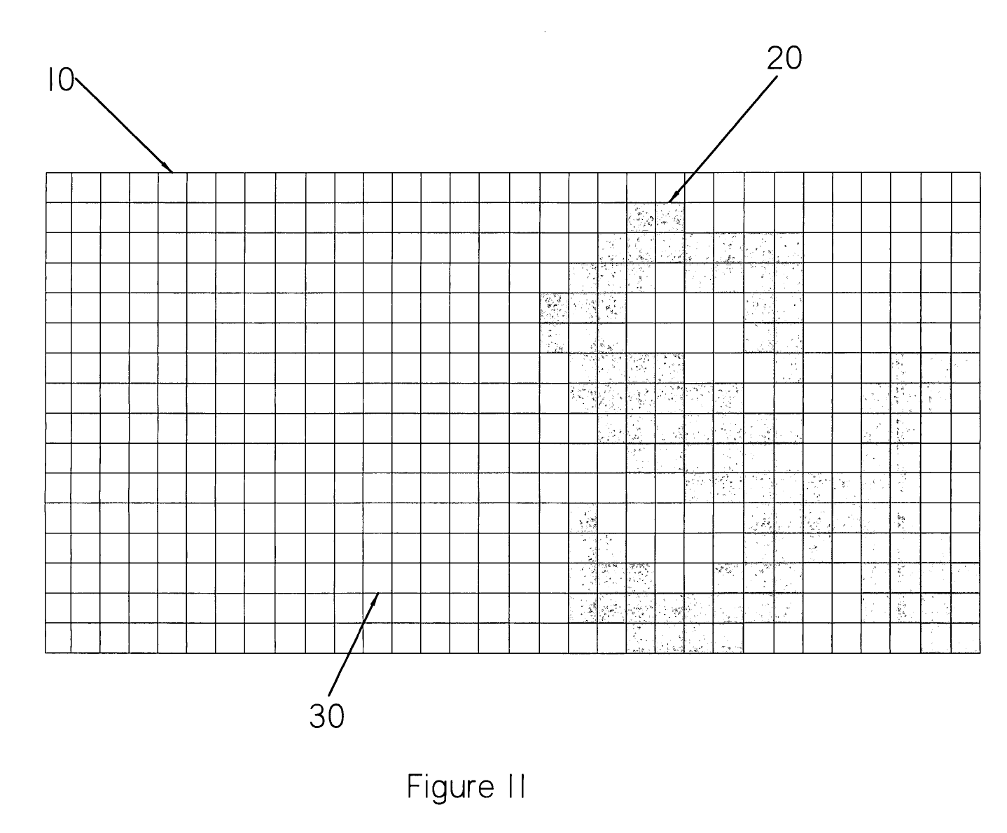

FIG. 11 shows an expanded view of a single large grid 10 that is divided into five hundred and twelve smaller grids 30. The grids 30 containing text or graphics are marked as a grayed out box 20. The total number of grayed out grids 20 compared to the total number of grids 30 contained in the large grid 10, will determine whether the large grid 10 is shown as grayed out or not. The software would set this value. If the percentage of grayed out grids 20 is below a specified percentage threshold, then the large grid 10 will not be marked as containing text or graphics, but if the percentage is above, then the large grid 10 will be grayed out, or marked as containing text or graphics. In another embodiment of the disclosed invention, in lieu of employing a simple grid scheme to determine the amount of text and graphics, optical character recognition (OCR) is used. In typical OCR software packages, there are several steps that must be done in order to ensure that the paper document to be read or digitized is converted correctly. The appropriate steps are to first physically scan in the document by using a scanner, or equivalent piece of hardware (in this invention, the document is already in digital format, as it is a HTML webpage document, or some other equivalent format). After the scanner scans the paper document, the digital “image” of the document is stored in the computer memory. The OCR software will then perform binarization of the image with the help of a suitable algorithm for determining thresholding to remove any colored background or watermark type image. Binarization is the process of converting the color or gray level image into a black and white binary image, with foreground as white and background as black. The next step is to check for any image skew, or rotation of the image. The skew may be caused while placing the paper on the scanner, or may be inherently present in the paper, even with lot of care, some amount of skew is inevitable. There are several algorithms for skew detection, and these will not be discussed here.

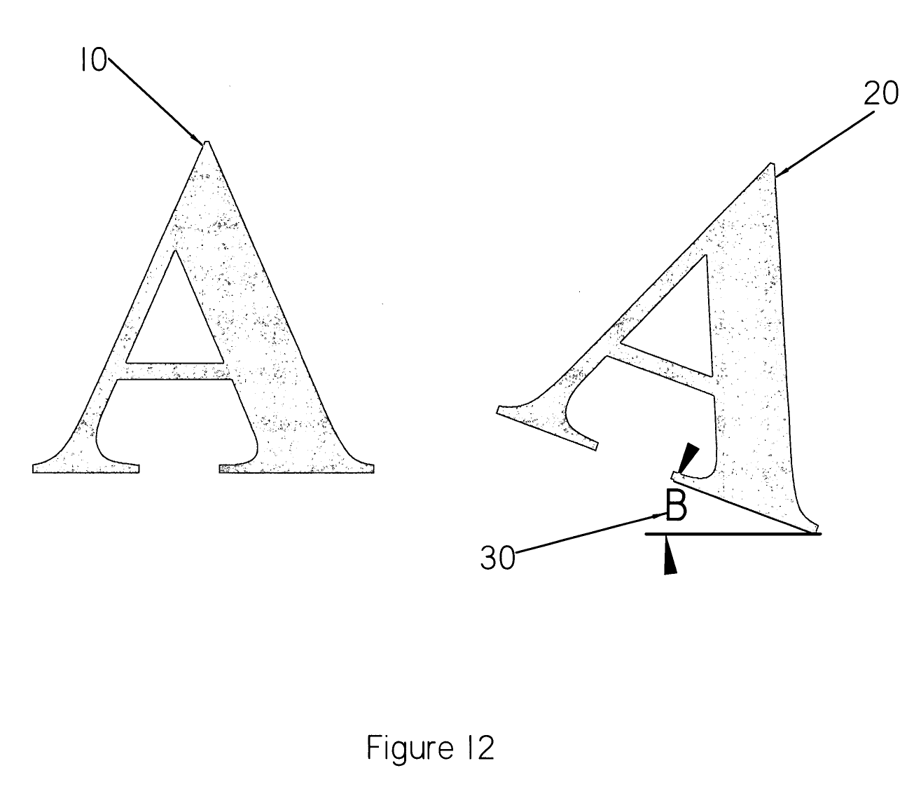

FIG. 12 details how skew affects text. There are two single letters of text shown, one with no skew 10, and the second character 20 shown offset from normal at some angle 30. This angle 30 would be expressed throughout the entire scanned paper document. After finding the amount of skew angle (if any), the image will need to be corrected. The described invention will be working with digital information from various sources, primarily that of HTML webpages, and thus, the step of checking for any image skew is superfluous. The full process of document digitization is being discussed only to familiarize the reader with the complete process. While skew detection is performed on the binarized document, correction, which involves rotating the image in the appropriate direction, is performed on the image to reduce quantinization effects that will affect the accuracy of any OCR algorithm (quantinization relates to the conversion of the analog image to a digital format, and can result in producing rough, jagged lines). The next step is to perform segmentation on the image (segmentation involves breaking the text in the page into lines, words and finally, characters). Horizontal projection profiles are employed for line detection and vertical projection profiles are employed for word detection. Connected component analysis is performed to extract the individual characters. The segmented characters are normalized before the recognition phase. Nearest neighborhood classifiers are employed to extract character information to aid in recognition. The recognized characters are then stored and compared to an internal database to obtain good recognition accuracy. In addition to all this processing, scaling of the individual characters may need to be done if the text contains different font values, or point sizes.

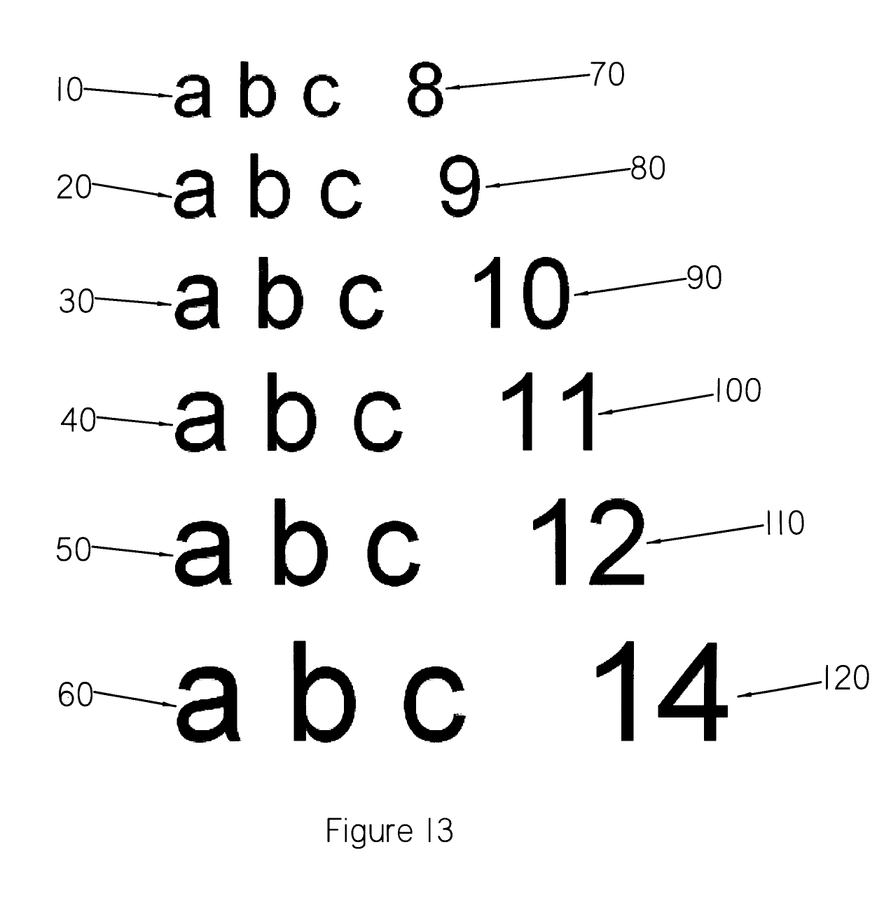

FIG. 13 shows enlarged views of several different common font sizes of the widely used “Arial” font type. The characters range from a small eight point size 10, with the font size indicated by the number to the right 70, to a fourteen point size 60, as indicated by the number fourteen 120 to the right of the font. The other font sizes detailed are a nine point font 20 indicated by the number to the right 80, a ten point font 30, indicated by the number to the right 90, an eleven point font 40, indicated by the number to the right 100, and a twelve point font 50, indicated by the number to the right 110. The ability to use a scaling algorithm will enable the OCR software to recognize a lowercase “a” at eight points, as easily as at fourteen points.

Reference Numerals:

FIG. 1:

10 Outline of a single sheet of standard 8.5″×11″ laser printer/copier paper scaled down to fit onto another 8.5″×11″.
20 Single line of text printed at the top of the page.
30 Large blank area of paper indicating that much of the paper was wasted.
40 Single line of text printed at the bottom of the page.
   FIG. 2:
10 Screen shot of a software print menu for allowing various functions to be utilized by a printer.
20 Print page range selection button.
30 Print page range text box for selecting number of pages to be printed.
   FIG. 3:
10 Detail showing page one of two pages printed from a laser printer showing information from an Edmund Scientific website.
20 Detail showing page two of two pages printed from a laser printer showing only a fraction of useful information from an Edmund Scientific website.
   FIG. 4:
10 Detail showing page two of the two pages printed from a laser printer showing information from an Edmund Scientific website after it has been converted to a monochrome or black and white image.
   FIG. 5:
10 Detail showing page two of the two pages printed from a laser printer showing information from an Edmund Scientific website after it has been converted to a monochrome or black and white image.
20 Detail showing how the image of the page is divided up into eighty-two equally spaced reference rows.
   FIG. 6:
10 Detail showing page two of the two pages printed from a laser printer showing information from an Edmund Scientific website after it has been converted to a monochrome or black and white image.
20 Detail showing how the image of the page is divided up into eighty-two equally spaced reference rows.
30 Detail showing how the each reference row that contains a certain percentage of text or graphics is completely shaded in dark gray.
   FIG. 7:
10 Detail showing page two of the two pages printed from a laser printer showing information from an Edmund Scientific website after it has been converted to a monochrome or black and white image.
20 Detail showing how the image of the page is divided up into eighty-two equally spaced reference rows.
30 Detail showing how the image of the page is divided up into thirty-two equally spaced reference columns.
   FIG. 8:
10 Detail showing page two of the two pages printed from a laser printer showing information from an Edmund Scientific website after it has been converted to a monochrome or black and white image.
20 Detail showing how the image of the page is divided up into eighty-two equally spaced reference rows.
30 Detail showing how the image of the page is divided up into thirty-two equally spaced reference columns.
40 Detail showing how each reference grid that contains a certain percentage of text or graphics is completely shaded in dark gray.
   FIG. 9:
10 Expanded view showing close up view of a portion of page two of the two pages printed from a laser printer showing information from an Edmund Scientific website.
20 Detail showing a single reference grid that is created by the intersection of the reference rows and reference columns.
30 Detail showing how each single reference grid is further subdivided into smaller grids to give information on whether to consider the large reference grid as containing text or graphics.
   FIG. 10:
10 Expanded view showing close up view of a portion of page two of the two pages printed from a laser printer showing information from an Edmund Scientific website.
20 Detail showing a single reference grid that is created by the intersection of the reference rows and reference columns.
30 Detail showing how each single reference grid is further subdivided into smaller grids to give information on whether to consider the large reference grid as containing text or graphics.
40 Detail showing how each small reference grid is indicated as containing text or graphics by filling in the small grid with a dark gray color.
   FIG. 11:
10 Expanded view showing close up view of a single large reference grid. The expanded view allows one to see more clearly the detail contained therein.
20 Detail showing how each small reference grid is indicated as containing text or graphics by filling in the small grid with a dark gray color.
30 Detail showing how each small reference grid is indicated as being empty or devoid of text or graphics by leaving it white.
   FIG. 12:
10 Detail showing an image of the letter “A”.
20 Detail showing an image of the same letter “A” that has been rotated from normal by a small amount.
30 Detail shows the angle that the image of the letter “A” has been rotated or skewed off normal.
   FIG. 13:
10 Detail of text created by using the Arial, eight-point font type.
20 Detail of text created by using the Arial, nine-point font type.
30 Detail of text created by using the Arial, ten-point font type.
40 Detail of text created by using the Arial, eleven-point font type.
50 Detail of text created by using the Arial, twelve-point font type.
60 Detail of text created by using the Arial, fourteen-point font type.
70 Number indicating the eight-point font size used to create the text.
80 Number indicating the nine-point font size used to create the text.
90 Number indicating the ten-point font size used to create the text.
100 Number indicating the eleven-point font size used to create the text.
110 Number indicating the twelve-point font size used to create the text.
120 Number indicating the fourteen-point font size used to create the text.

1. A paper saver comprising:
a computer processor for recognizing blank space in a page of a document to be printed, the processor being operative to cancel printing of the page if a percentage of the blank space exceeds a user selectable threshold.

2. A method for saving paper in a printing environment comprising the steps of:
storing an image in memory;
identifying each line of the image based upon a percentage of blank space;
determining a percentage of blank space on each page based upon the identifying step; comparing the percentage to a threshold; and
preventing printing of the respective page if the percentage is above the threshold.

3. A method as recited in claim 2, further comprising the step of disabling the method by a user.

4. A method for saving paper comprising the steps of:
defining a grid for a last page of document to be printed, the grid having a plurality of pixels;
determining a subset of the plurality of pixels to be printed upon;
determining a page ratio between the subset and the plurality;
selecting a ratio threshold; and
determining to print the last page based upon a comparison of the page ratio to the ratio threshold.
